(19) United States
(12) Patent Application Publication
(10) Pub. No.: US 2024/0202305 A1
(43) Pub. Date: Jun. 20, 2024

(54) TWO-TRANSISTOR CHIP AND THREE-TRANSISTOR CHIP IDENTIFICATION BIT CELLS

(71) Applicant: International Business Machines Corporation, Armonk, NY (US)

(72) Inventors: Kangguo Cheng, Schenectady, NY (US); Julien Frougier, Albany, NY (US); Ruilong Xie, Niskayuna, NY (US); Chanro Park, Clifton Park, NY (US); Min Gyu Sung, Latham, NY (US)

(21) Appl. No.: 18/065,923

(22) Filed: Dec. 14, 2022

(51) Int. Cl. G06F 21/44; G06F 21/73; G11C 7/24; H01L 23/525; H01L 29/06

(52) U.S. Cl. CPC G06F 21/44; G06F 21/73; G11C 7/24; H01L 23/5252; H01L 29/0626

(57) ABSTRACT

Methods and structure are provided for programming an array of bit cells to create a unique identification code for a semiconductor structure. Random failure of a gate dielectric at a transistor is utilized to generate a binary identification code. A portion of the gate is located above a source and a portion is located above a drain, a first logic state can be applied where the gate dielectric fails source-side and a second logic state can be applied where the gate dielectric fails drain-side. The gate dielectric preferentially fails as a function of its thinness versus the thickness of a second gate dielectric of a second transistor which acts as a control for failure of the gate dielectric. Failure is initiated based upon a voltage applied to both the thin gate dielectric and the thick dielectric. A bit cell can include two or three transistors, e.g., field effect transistors.

### BACKGROUND

Identification of integrated circuits (ICs) is essential to ensure the authenticity of semiconductor chips and to prevent counterfeiting. Using a counterfeit IC can lead to catastrophic effects such as information leaking, hardware failure, etc. Further, counterfeit ICs in the marketplace can result in lost revenue and damaged reputation for a manufacturer of genuine ICs. Typically ICs are marked with an external identifier after fabrication of the IC, e.g., with pre-assigned numbers printed on the casing of the IC. A drawback of such an approach for identifying an IC is that an adversary can forge counterfeit ICs and print markings and numbers on them to match the markings and numbers of an original, genuinely manufactured IC.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

According to one or more embodiments, a semiconductor device is presented, wherein the semiconductor device can comprise a first transistor fabricated to include a first gate electrode and a first gate dielectric, wherein the first gate dielectric can be located between the first gate electrode and a first channel region. The semiconductor device can further comprise a second transistor fabricated to include a second gate electrode and a second gate dielectric, wherein the second gate dielectric can be located between the second gate electrode and a second channel region. In an embodiment, the second transistor can be electrically connected to the first transistor, wherein the second gate dielectric can be configured to breakdown prior to breakdown of the first gate dielectric upon application of a voltage to the first transistor. In another embodiment, a thickness of the second gate dielectric between the second gate electrode and the second channel region can be thinner than a thickness of the first gate dielectric between the first gate electrode and the first channel region. In a further embodiment, the breakdown of the second gate dielectric can be irreversible. In another embodiment, the voltage can be a source-drain voltage.

In a further embodiment, the semiconductor device can further comprise a first source region and a first drain region, wherein the first source region can be located on a first side of the first channel region and the first drain region can be located on a second side of the first channel region wherein the first side of the first channel region and the second side of the first channel region are on opposite sides of the first channel region, and a first portion of the first gate electrode is located adjacent to the first source region and a second portion of the first gate electrode is located adjacent to the first source region. In another embodiment, the semiconductor device can further comprise a second source region and a second drain region, wherein the second source region can be located on a first side of the second channel region and the second drain region can be located on a second side of the second channel region wherein the first side of the second channel region and the second side of the second channel region are on opposite sides of the second channel region, and a first portion of the second gate electrode is located adjacent to the second source region and a second portion of the second gate electrode is located adjacent to the second source region. In an embodiment, breakdown of the second gate dielectric can occur at the first portion of the second gate dielectric or at the second portion of the second gate dielectric.

In another embodiment regarding the semiconductor device, in the event of the breakdown of the second gate dielectric occurring at the first portion of the second gate dielectric, a first logic state can be applied to the semiconductor device, and in the event of the breakdown of the second gate dielectric occurring at the second portion of the second gate dielectric, a second logic state can be applied to the semiconductor device, wherein the first logic state and the second logic state are disparate.

In an embodiment, the semiconductor device can be a bit cell identified by the first logic state or second logic state applied thereto. In another embodiment, the bit cell can be located in an array of bit cells and the first logic state or second logic state applied to the bit cell can be incorporated into an identifier generated based upon the respective logic state applied to each of the bit cells in the bit cell array. In another embodiment, the array of bit cells can form a physical unclonable function.

In a further embodiment, the semiconductor device can further comprise a third transistor fabricated to include a third gate electrode and a third gate dielectric. In an embodiment, the third gate dielectric can be located between the third gate electrode and a third channel region. In another embodiment, a first thickness of the first gate dielectric between the first gate electrode and the first channel region and a third thickness of the third gate dielectric between the third gate electrode and the third channel region can be equal. In another embodiment, a second thickness of second gate dielectric between the second gate electrode and the second channel region can be less than the first thickness and the third thickness. In another embodiment, the first transistor and the third transistor can be connected by a wordline, wherein application of the voltage to the first transistor is also applied to the third transistor via the wordline to cause breakdown of the second transistor.

In a further embodiment, a semiconductor bit cell is presented, comprising a first transistor comprising a first gate dielectric located between a first gate electrode and a first channel region, wherein a first source is located on a first side of the first channel region and a first drain is located on a second side of the first channel region, the first gate dielectric has a first thickness between the first gate electrode and the first channel region substrate. The semiconductor bit cell can further comprise a second transistor comprising a second gate dielectric located between a second gate electrode and a second channel region, wherein a second source is located on a first side of the second channel region and a second drain is located on a second side of the second channel region, the second gate electrode is electrically connected to the first transistor via the first drain, the second gate dielectric has a second thickness between the second gate electrode and the second channel drain, the second thickness is less than the first thickness, wherein, in the event of a breakdown voltage is applied to the second transistor, the second gate dielectric is configured to irreversibly breakdown prior to breakdown of the first gate dielectric. In a further embodiment regarding the semiconductor bit cell, a first portion of the second gate dielectric can be adjacent to the second source and a second portion of the second gate dielectric is adjacent to the second drain, and breakdown of the second gate dielectric occurs at either the first portion of the second gate dielectric or at the second portion of the second gate dielectric. In a further embodiment, in the event of the breakdown of the second gate dielectric occurs at the first portion of the second gate dielectric, the semiconductor bit cell is in a first logic state, and in the event of the breakdown of the second gate dielectric occurs at the second portion of the second gate dielectric, the semiconductor bit cell is in a second logic state, wherein the first logic state and second logic state are disparate. In a further embodiment, the bit cell can be located in an array of bit cells, wherein the logic state of the bit cell can be incorporated into an identification code generated based on a logic state respectively assigned to each of bit cells located in the array.

In another embodiment, a method is provided, wherein the method comprises creating an identification code for a semiconductor device. In an embodiment, the method can comprise fabricating a bit cell located on the semiconductor device, wherein the bit cell comprises a first transistor including a first gate dielectric having a first thickness and a second transistor including a second gate dielectric having a second thickness, wherein the first thickness is greater than the second thickness and the first transistor is electrically connected to the second transistor. In a further embodiment, the method can comprise applying a voltage to the first transistor wherein the voltage has a magnitude sufficient to cause breakdown of the second gate dielectric and insufficient to cause breakdown of the first gate dielectric. In a further embodiment, the second transistor can be located on a channel region, wherein the channel region separates a source region and a drain region, a first portion of the second gate dielectric is adjacent to a first portion of the drain region and a second portion of the second gate dielectric is adjacent to a first portion of the source region. In a further embodiment, the method can further comprise determining whether the breakdown of the second gate dielectric occurred at the first portion of the second gate dielectric or at the second portion of the second gate dielectric. In response to determining that breakdown of the second gate dielectric occurred at the first portion of the second gate dielectric, the method can further comprise assigning a first logic state to the bit cell. In response to determining that breakdown of the second gate dielectric occurred at the second portion of the second gate dielectric, the method can further comprise assigning a second logic state to the bit cell, wherein the first logic state and the second logic state are disparate. In an embodiment, the bit cell can be located in an array of bit cells, wherein the assigned logic state can be incorporated into an identification code generated based on a logic state respectively assigned to each of bit cells located in the array. In a further embodiment, the method can further comprise fabricating a third transistor including a third gate dielectric having the first thickness, a gate electrode of the third transistor is electrically connected to a gate electrode of the first transistor via a wordline, wherein the voltage applied to the first transistor is applied to the third transistor via the wordline creating an electric field at the second gate dielectric.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 presents IC structure 100 facilitating identification of the IC as a function of dielectric breakdown, in accordance with one or more embodiments described herein.

FIG. 2 presents circuit diagram 200 of IC structure 100, in accordance with one or more embodiments described herein

FIG. 3 presents circuit diagram 300 of IC structure 100 illustrating breakdown of the gate dielectric occurring source side, in accordance with one or more embodiments described herein.

FIG. 4 presents circuit diagram 400 of structure 100 illustrating breakdown of the gate dielectric occurring drain side, in accordance with one or more embodiments described herein.

FIG. 5 presents structure 500, an IC with a series of bit cells located thereon, with IC identification being based upon dielectric breakdown state of the series of bit cells, in accordance with one or more embodiments described herein.

FIG. 6 depicts an equivalent circuit diagram 600 illustrating a programming operation of antifuses, in accordance with one or more embodiments described herein.

FIG. 7 depicts an equivalent circuit diagram 700 illustrating the programming operation causing breakdown of a source side antifuse, in accordance with one or more embodiments described herein.

FIG. 8, circuit representation 800, presents a scenario where breakdown of a gate dielectric has occurred source side, in accordance with one or more embodiments described herein.

FIG. 9, circuit representation 900, presents a scenario, where breakdown of a gate dielectric has occurred drain side, in accordance with one or more embodiments described herein.

FIG. 10 presents system 1000 configured to program and read an identification generated based on breakdown statuses of an array of bit cells comprising two FET structures that include thin gate dielectrics, in accordance with one or more embodiments described herein.

FIG. 11 presents a methodology 1100 for generating a unique ID for an IC, in accordance with one or more embodiments described herein.

FIG. 12 presents a methodology 1200 for generating a unique ID for an IC, in accordance with one or more embodiments described herein.

FIG. 13 presents a rudimentary depiction of IC structure 1300 facilitating identification of the IC as a function of dielectric breakdown, in accordance with one or more embodiments described herein.

FIG. 14 presents system 1400 configured to read an identification generated based on breakdown statuses of a group of 3 FET structures comprising thin gate dielectrics, in accordance with one or more embodiments described herein.

FIG. 15 presents a methodology 1500 for generating a unique ID for an IC, in accordance with one or more embodiments described herein.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details. In other instances, well-known structures and devices are shown in block diagram form in order to facilitate describing the embodiments in additional detail.

### Overview

The various embodiments presented herein present structures and methods for forming IC identification as a function of breakdown of a gate dielectric of a transistor, e.g., a field effect transistor (FET). As further described, an IC can be fabricated having various structures such as a memory, CPU, etc., as well as one or more bit cells arranged on the IC, e.g., forming a peripheral array of bits cells. Based upon a respective embodiment, a bit cell can include 2 FETs or 3 FETs, plus other necessary structures including gate electrodes, sources, drains, wordlines, source lines, bitlines, etc., as required to facilitate programming and reading of a logic state of a bit cell. As further described, during “programming” of a bit cell, breakdown of a gate dielectric is effected, wherein the breakdown can occur at either the gate-drain interface or at the gate-source interface. One or more “read” operations can be performed on a bit cell post-programming, wherein the read operation can apply/measure voltages and electrical currents across the bit cell with the measurements being affected by the state of the bit cell after the gate dielectric has broken down. Based on the read measurements, the state of the bit cell can be determined and a logic state subsequently applied. Breakdown of the bit cell is a physical failure of the gate dielectric, such that the failure cannot be reversed, and subsequently the bit cell will have an according logic state assigned to it that cannot be changed. Owing to the failure of the gate dielectric occurring within a bit cell which is subsequently encapsulated and packaged as part of the IC manufacturing process, an identification code (identifier) of the IC based upon the respective logic states of the array of bits cells renders the identification code unique to the IC and is difficult to counterfeit.

A bit cell can be fabricated comprising a first FET having a thin gate dielectric material and a second FET having a thick gate dielectric, such that during programming, application of a voltage across the bit cell promotes preferential failure of the thin gate dielectric material prior to failure of the thick gate dielectric occurs. The breakdown of the gate dielectric is effectively random, wherein the randomness can result from variation in fabrication artifacts such as device dimension, material composition, structural defect within the material, etc. With a gate dielectric being manufactured such that it is largely consistent materially and structurally throughout, breakdown of the gate dielectric adjacent to a drain (drain-side) or a source (source-side), statistically there is a 50% chance of gate dielectric breakdown occurring at the gate-source interface and 50% chance of gate dielectric breakdown occurring at the gate-drain interface. The random breakdown of the respective bit cell gate dielectrics arranged on an IC can be utilized to generate a random ID that is unique to the IC. The randomness of fabricating a bit cell renders it hard to predict on which side breakdown of gate dielectric will occur. Hence, the generated IC identification code is unique for each IC, and further, is difficult to reproduce in a counterfeiting operation. It is to be appreciated that the various voltages presented herein are provided for understanding and are examples of such voltages. Voltages used, e.g., during programming, can be based upon the respective thicknesses of the thick and thin gate dielectrics, wherein a first voltage is a breakdown voltage for a thin gate dielectric having a thickness of x, while a second voltage is a breakdown voltage for a thin gate dielectric having a thickness of y. where the first voltage and the second voltage are disparate, and x and y thicknesses are disparate.

In an embodiment, an array of bit cells can be utilized to create a physical unclonable function (PUF). A PUF can utilize a challenge-response pair function. Challenges can be coordinates of randomly selected bits cells in the array and responses can be the corresponding logic states determined for each randomly selected bit cell (e.g., by a analysis system comprising column and row decoders operating in conjunction with a sense amplifier, an analog-to-digital converter, etc.). In an embodiment, the logic state of every bit cell in the bit cell array can be read, with an identifier of the IC being generated based on all of the bit cell logic states. In another embodiment, a subset of bit cells in the bit cell array can be selected and an IC identifier determined based upon the respective logic state of the subset of bit cells.

The various embodiments presented herein can be utilized in any suitable semiconductor device, IC fabrication, and/or transistor architecture. For example, complementary metal-oxide-semiconductor (CMOS) technology such as nanosheet, stacked CMOS, FinFET, vertical transistor CMOS, planar CMOS, MOS technology, and the like. Further, while the embodiments presented herein are directed towards basic planar transistor architecture, it is to be appreciated that the various concepts presented herein are applicable to any suitable structure including FinFET, Gate-All-Around Nanowire/Nanosheet FET, Vertical-Transport FET (VTFET) or even Stacked-FET (NFET stacked on PFET or vice versa), and suchlike.

As previously mentioned, two approaches to IC identification are presented herein, a bit cell utilizing a two-FET structure and a bit cell utilizing a three-FET structure:

### 1. Two FET Structure Overview

One or more embodiments can relate to an IC comprising two FETs, a first FET with a thick gate dielectric (aka EG FET) functioning as a read transistor, and a second FET with a thin gate dielectric (aka SG FET) storing the bit information. IC identification is generated based on whether the thin gate dielectric breakdown occurs on the source side of the SG FET or on the drain side of the SG FET. The generated identification is random but unique to each IC. As described herein, the IC identification is embedded within the IC circuitry and, accordingly, given the identification is based on a random physical phenomenon, the identification is hard to forge.

### 2. Three FET Structure Overview

Further embodiments can relate to an IC comprising 3 FETs, two FETs (a first FET and a second FET, aka EG FETs) both have a thick gate dielectric functioning as read transistors, and a FET (a third FET, aka SG FET) with a thin gate dielectric storing the bit information. IC identification is generated based on whether the gate dielectric breakdown occurs at a first source/drain (S/D) side of the SG FET or at a second S/D side of the SG FET. The generated identification is random but unique to each IC. As described herein, the IC identification is embedded within the IC circuitry and, accordingly, given the identification is based on a random physical phenomenon, the identification is hard to forge.

In an aspect, a certainty of the operational state of the 3 FET bit cell after breakdown of the thin gate dielectric of the SG FET can be greater than a certainty of the operational state of the 2 FET bit cell after breakdown of the thin gate dielectric of the SG FET. Accordingly, when an identification of an IC is to be achieved using an array of bit cells, as described herein, where real estate on the IC allows, bit cells utilizing a 3 FET structure may be preferred over bit cells utilizing a 2 FET structure owing to the greater certainty of operational state of the 3 FET structure. Further, while the various embodiments presented herein depict structures with specific n-type and p-type doped materials, the materials can be replaced such that a structure described herein as being formed with a n-type material, the material can equally be a p-type material, and vice versa.

As used herein, m is any positive integer and n is any positive integer.

It is to be appreciated that while the various embodiments presented herein are described with regard to utilizing FETs, the various embodiments are equally applicable to any transistor structure or other system components where failure of a first component can be programmed, with the failure controlled by a second component having similar structure and operation as the first component.

### Two FET Structure and Operation

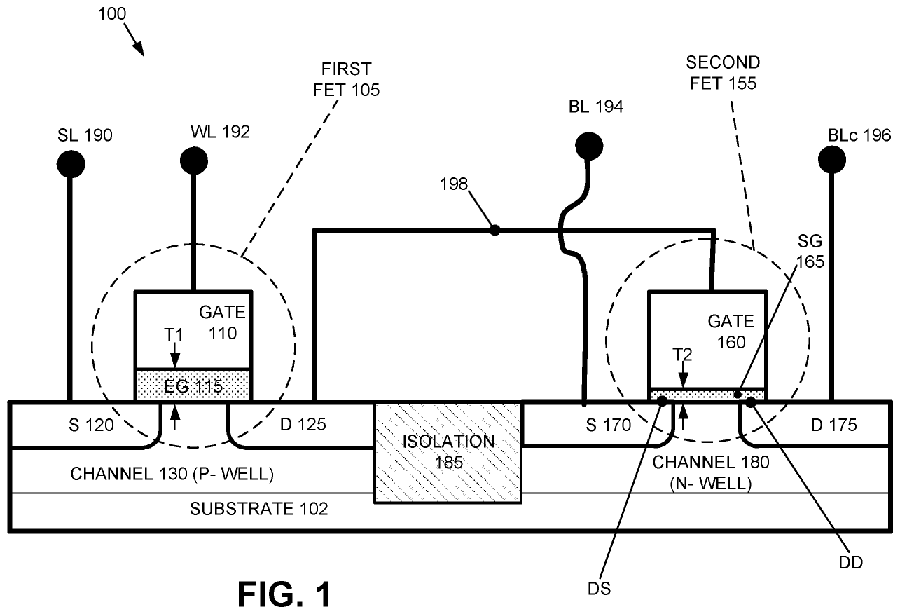

Turning to the figures, FIG. 1 presents IC structure 100 facilitating identification of the IC as a function of dielectric breakdown, in accordance with one or more embodiments described herein. The IC structure 100 can be a bit cell.

As shown in FIG. 1, a semiconductor substrate 102 (e.g., a silicon (Si)-containing structure) has formed thereon a pair of FETs. A first FET 105 comprises a first gate electrode 110 located on a first gate dielectric 115. The first gate dielectric 115 is located on a first source (S) 120, a first drain (D) 125, and a first channel 130, wherein the first channel 130 is located on the substrate 102 between the first source 120 and the first drain 125. A first portion of the first gate dielectric 115 is located over a first portion of the first source 120 and a second portion of the first gate dielectric 115 is located over a first portion of the first drain 125. The first FET 105 can be an EG NFET (n-type FET), with source 120 and drain 125 being n-type material, and the channel 130 can be a p-type well.

A second FET 155 comprises a second gate electrode 160 located on a second gate dielectric 165. The second gate dielectric 165 is located on a second source 170, a second drain 175, and a second channel 180, wherein the second channel 180 is located between the second source 170 and the second drain 175. A first portion of the second gate dielectric 165 is located over/adjacent to a first portion of the second source 170 (region DS) and a second portion of the second gate dielectric 165 is located over/adjacent to a first portion of the second drain 175 (region DD). The second FET 155 can be a SG PFET (p-type FET), with source 170 and drain 175 being p-type material, and the channel 180 can be a n-type well.

The structure 100 comprising the first FET 105, the second FET 155, first gate electrode 110, second gate electrode 160, etc., can also be referred to as a “bit cell”. Hence, a series of bit cells can be arranged across an IC forming a peripheral array of bit cells, wherein the arrangement of bit cells and their respective programmed logic state can be utilized to generate a unique identifier for the IC, as further described herein (e.g., FIGS. 5 and 10).

The first FET 105 and the second FET 155 are separated by an isolating structure 185. In an embodiment, the isolating structure 185 can be a shallow trench isolation (STI) structure. Isolating structure 185 can be formed from any suitable material to separate respective n-doped drain 125 region and p-doped source 170 region, wherein such a material can be an insulating material such as an oxide.

The first gate dielectric 115 is located between the first gate electrode 110 and the first source 120, first drain 125, and first channel 130. As shown, the first gate dielectric 115 has a first thickness T1. Further, the second gate dielectric 165 is located between the second gate electrode 160 and the second source 170, second drain 175, and second channel 180. The second gate dielectric 165 has a second thickness T2. In an embodiment, T1>T2, such that thickness T1 enables the first gate dielectric 115 to sustain high voltage operation of the first FET 105, and the thickness T2 causes the second gate dielectric 165 to breakdown when the second FET 155 is operating under the high voltage (and corresponding high electric field existing at the second gate dielectric 165). Accordingly, an applied voltage (aka breakdown voltage) required to cause structural breakdown of the second gate dielectric 165 is less than a voltage required to cause structural breakdown of the first gate dielectric 115. Hence, failure of the second gate dielectric 165 occurs preferentially and prior to failure of the first gate dielectric 115.

During operation of the various structures presented herein (e.g., structure 100 and structure 1300 (as further described)) various voltages can be applied. For example, a gate voltage (aka. a turn-on voltage, a first voltage) can be applied with the purpose to turn-on the channel (e.g., any of channels 130, 180, 1382, 1384, 1386) to allow conduction between the source and drain respectively adjacent to the channel and further adjacent to the gate dielectric. The purpose of the gate voltage is to turn on the thick gate transistor(s) device, however the gate voltage does cause structural breakdown of the second gate dielectric. Structural breakdown of the second gate diclectric occurs when a source-drain voltage (aka. second voltage) is applied. where the source-drain voltage causes carrier conduction across the channel. Hence, while reference is made herein to a breakdown voltage, it is to be appreciated that the terms “breakdown voltage” and “source-drain voltage” can be used interchangeably.

Owing to the first portion of the second gate dielectric 165 being located over a first portion of the second source 170 (region DS) and a second portion of the second gate dielectric 165 being located over a first portion of the second drain 175 (region DD), during high voltage operation, breakdown of the second gate dielectric 165 can occur at either the first portion of the second gate dielectric 165 located over the first portion of the second source 170 (region DS), or the second portion of the second gate dielectric 165 located over the first portion of the second drain 175 (region DD). As further described, binary logic can be applied based on whether the breakdown of the gate dielectric 165 occurs at region DS or DD. For example, if the breakdown of the gate dielectric 165 occurs at region DS, a logic state of “1” can be assigned to that breakdown, while, if the breakdown of the gate dielectric 165 occurs at region DD, a logic state of “0” can be assigned to that breakdown. Accordingly, for an arrangement of bit cells, based upon whether the breakdown occurred at DD or DS for each respective FET in the arrangement, and the corresponding logic state of “1” or “0” ascribed thereto, when the logic states of the respective bit cells are read, a unique identifier can be formed and identified. Assignment of the respective logic states is arbitrary with a logic state of “0” assigned to breakdown of the gate dielectric 165 occurring at region DS and a logic state of “1” assigned to breakdown of the gate dielectric 165 occurring at region DD. In an embodiment, consistent application of the respective logic states across the array of bit cells enables the identification code to be generated.

As further shown in FIG. 1, a source line (SL) 190 circuitry is connected to the first source 120, a wordline (WL) 192 circuitry is connected to the first gate electrode 110, a bitline (BL) 194 circuitry is connected to the second source 170, and a complimentary bitline (BLc) 196 circuitry is connected to the second drain 175. The first drain 125 is connected via an electrical connector (circuitry) 198 to the second gate electrode 160. Hence, when a voltage is applied to the first FET 105 (e.g., during a programming phase), the voltage can be further applied to the second FET 155 via the connector 198. As further described, respective voltages can be applied by and/or measured at the SL 190, WL 192, BL 194, and/or BLc 196 to (a) initiate breakdown of the second gate dielectric 165 at DD or DS and (b) enable a logic state “1” or “0” to be generated based upon the location of the breakdown and respective electrical currents determined based thereon.

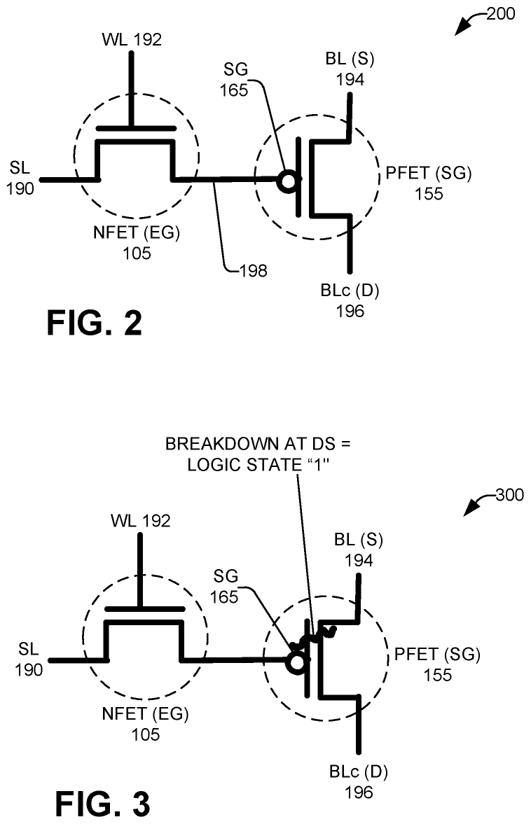

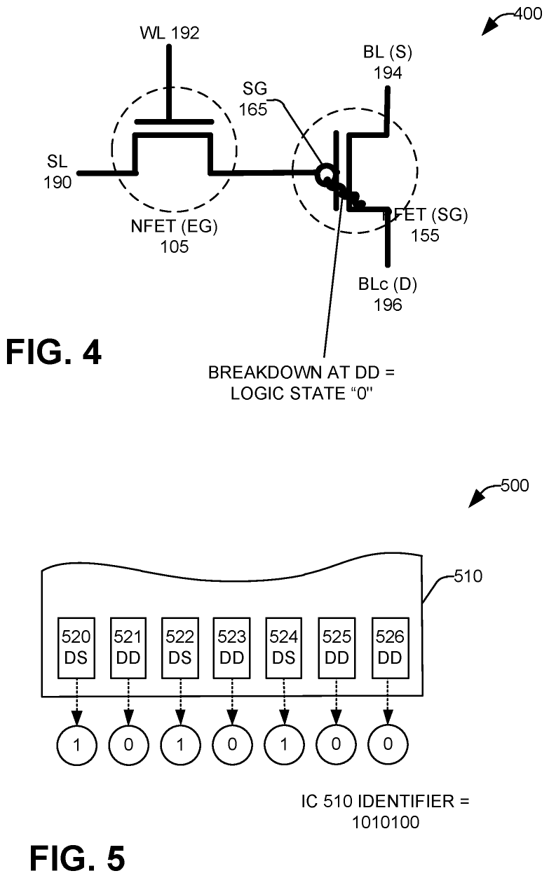

FIGS. 2-4 present respective circuit diagrams 200, 300, and 400 for the configuration presented in FIG. 1, as well as furthering the concept of dielectric breakdown occurring at DD or DS. FIGS. 2-4 illustrate the first FET 105 and the second FET 155, in conjunction with SL 190, WL 192, BL 194, BLc196, and drain 125 connected to the second gate electrode 160 via connector 198. FIG. 3, circuit diagram 300, illustrates breakdown of gate dielectric 165 occurring at DS, with a corresponding logic state “1” assigned thereto. FIG. 4, circuit diagram 400, illustrates breakdown of gate dielectric 165 occurring at DD, with a corresponding logic state of “0” assigned thereto.

Turning momentarily to FIG. 5, the concept of an IC identification being based upon dielectric breakdown state of a series of bit cells located on the IC is presented, in accordance with one or more embodiments described herein. FIG. 5, structure 500, illustrates an IC 510 having a series of bit cells 520-526 located thereon (e.g., as a peripheral array of bits cells), wherein the bit cells 520-526 are multiples of the two FET structure 100 presented in FIG. 1. In the example presented in FIG. 5, based upon respective failure of individual FETs in the bit cells 520-526 occurring at either DS with an assigned logic state of “1” or at DD with an assigned logic state of “0”, the IC 510 has an identification of “1010100”, as determined based upon one or more embodiments further presented herein. The bit cells 520-526 can also be formed with three FET structures and achieve the same functionality as two FET structures.

### Two FET Structure—Programming Operation

To further understanding, utilizing the various embodiments presented herein to force a breakdown of the gate dielectric 165 at either DD or DS, the breakdown process is conceptually similar to the gate dielectric 165 at region DD or DS operating like an antifuse.

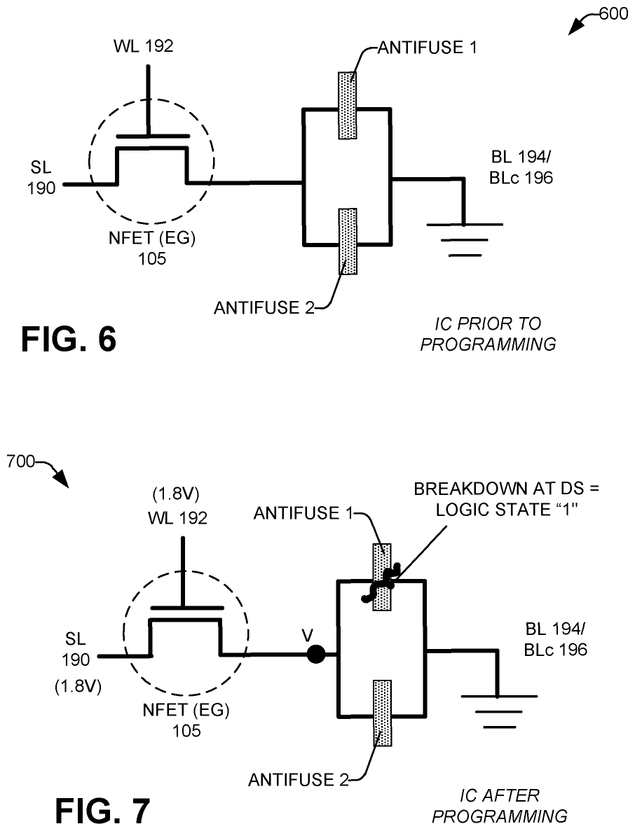

FIG. 6 and FIG. 7 depict an equivalent circuit diagram 600 and 700 illustrating a bit cell 100 in an unprogrammed state (FIG. 6) and after programming (FIG. 7), in accordance with one or more embodiments presented herein. A conventional electrical fuse initially operates with a low resistance and is designed to permanently break (aka blow) an electrically conductive path, e.g., when a current through the path exceeds a specified limit. An antifuse is an electrical device that performs in an opposite manner to a conventional fuse, wherein the antifuse initially operates with a high resistance, and “programming the antifuse” converts the antifuse into a permanently conductive path, e.g., when the voltage across the antifuse exceeds a certain level. Hence, when a voltage applied to the second gate electrode 160 is sufficient to cause breakdown of the gate dielectric 165, a conductive path is created at region DS or DD where the breakdown of the gate dielectric 165 occurred. As previously mentioned (per FIG. 1), the first gate electode 110 is electrically coupled, via first drain 125 and connector 198, to the second gate electrode 160 and the second gate dielectric 165. Thus, when a sufficiently high voltage is applied to the first gate electrode 110 to cause breakdown of the gate dielectric 165 at either DS or DD, a permanently conductive path is formed between the first gate electrode 110 and either the second source 170 or the second drain 175, depending upon whether the breakdown occurred at DS or DD. Furthermore, the breakdown of the second gate dielectric 165 at DS or DD is not reversible, once the portion of the second gate dielectric 165 at DS or DD fails, the breakdown is permanent, and accordingly, the two FET structure (per FIG. 1) is permanently programmed to have a logic state of “1” or “0”.

Programming of the two FET structure comprises:

1) turn on the first FET 105 (EG NFET) by applying a high voltage on WL 192 and SL 190. BL 194 and BLc 196 are grounded.

2) High voltage on SL 190 passes to the drain 125 of the first FET 105 and the second gate electrode 160 of the second FET 155 (SG PFET), via connector 198.

3) The channel 180 of the second FET 155 is off owing to BL 194 and BLc 196 being grounded and the voltage at the gate electrode 160 is positive.

4) A high electric field is generated across the thin gate dielectric 165 in regions adjacent to DS and DD regions (e.g., wherein the gate dielectric 165 overlaps the second source 170 region and second drain 175 region). As previously described, an antifuse is formed in each overlapped region, e.g., antifuse 1 at DS and antifuse 2 at DD.

5) As depicted in FIG. 6, the entire cell is equivalent to a pair of antifuses operating in parallel. Further, the first FET 105 can function as an access transistor.

6) FIG. 7 illustrates the programming operation causing breakdown of the source side antifuse 1, in accordance with one or more embodiments described herein. The programming operation is “self-limiting”, such that once one of the antifuses (either of antifuse 1 or antifuse 2) breaks down, the other one will remain intact/unprogrammed. Hence, region DS breaks down while region DD remains intact.

Table 1, below, presents various example voltages applied and read during respective operations in creating an identifier for IC 100. The program operation details voltages applied during programming of the gate dielectric 165, and the read operation details voltages applied and measured when determining which portion (e.g., DS or DD) of the gate dielectric 165 has broken down, for which a respective logic state of “1” or “0” can be applied (as further described below).

TABLE 1
EXAMPLE VOLTAGES AND BIAS FOR PROGRAM,
READ, AND STANDBY OPERATIONS AT RESPECTIVE
COMPONENTS IN A TWO FET BIT CELL.

| OPERATION | WL 192 | SL 190 | BL 194 | BLc 196 |
|---|---|---|---|---|
| Program | 1.8 V | 1.8 V | 0 | 0 |
| Read | 1.8 V | 0 | 0.7 V | Floating |
| Standby | 0 | 0 | 0 | 0 |

When the first FET 105 is in an ON state, SL 190 voltage (V_{SL}) is divided between the first FET 105 and the antifuses 1 and 2 (regions DS and DD of gate dielectric 165). Voltage across the antifuses can be determined per Equation 1:

$$V = {V}_{S L} \times \frac{{R}_{1} {R}_{2}}{{R}_{1} + {R}_{2}} / ( \frac{{R}_{1} {R}_{2}}{{R}_{1} + {R}_{2}} + {R}_{o n} ) \qquad Eqn . 1$$

where R₁ is the resistance of antifuse 1, R₂ is the resistance of the antifuse 2, and Rₒₙ is the resistance of the first FET 105.

Prior to breakdown of the gate dielectric 165, R₁>>Rₒₙ and R₂>>Rₒₙ. Accordingly, virtually the entire voltage V_{SL} drops across antifuse 1 and antifuse 2.

As previously mentioned, due to natural variation of processing/material, any slight difference between antifuse 1 and antifuse 2 will cause the electrically inferior antifuse to breakdown first. For example, once antifuse 1 breaks down, R₁ drops abruptly, such that R₁<<R₂, voltage across antifuse 2 drops, per Equation 2:

$$V = {V}_{S L} \times \frac{{R}_{1}}{{R}_{1} + {R}_{o n}} ≪ {V}_{S L} \qquad Eqn . 2$$

such that antifuse 2 remains in an unprogrammed state, e.g., antifuse 2 remains intact.

### Two FET Approach—Read Operation

With reference to the Read operation voltages presented in TABLE 1, the read operation comprises measuring electrical current at BL 194 with WL 192=1.8V, SL 190=0, BL 194=0.1V (small voltage) and BLc is floating. The first FET 105 is in an ON state while the second FET 155 is in an OFF state.

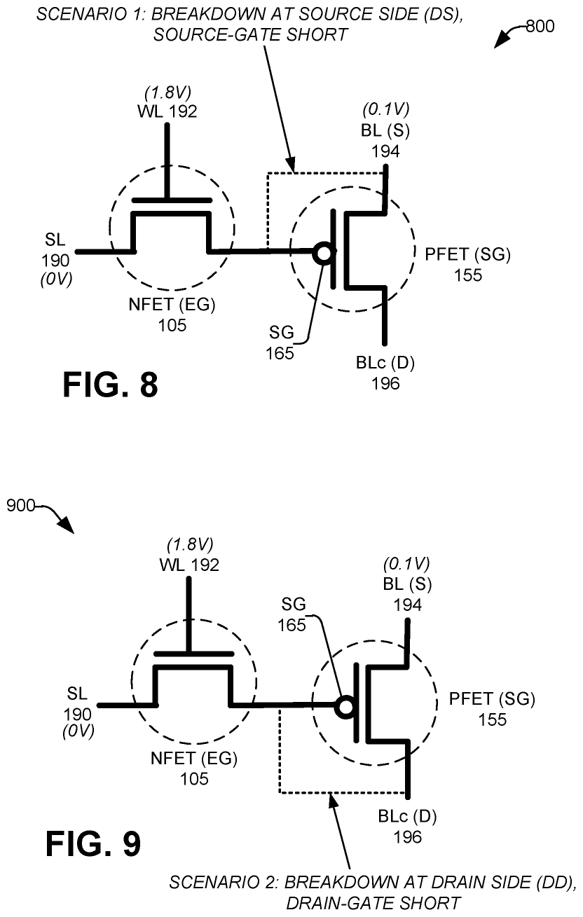

FIG. 8, circuit representation 800, presents a first scenario where breakdown of the gate dielectric 165 has occurred at DS (e.g., at source 170 side/BL 194 side), this is equivalent to source-gate shorting of the second FET 155. A large current flows through, and measured at, BL 194, and accordingly, the logic state for the bit cell is assigned as “1” for the first scenario.

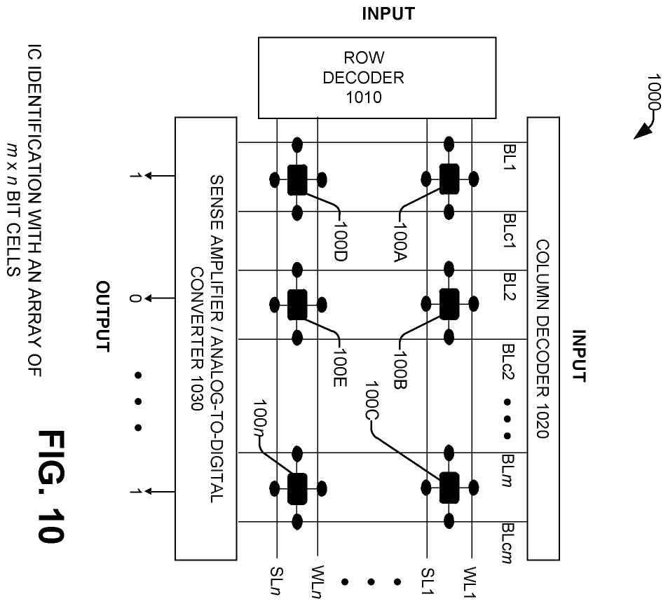

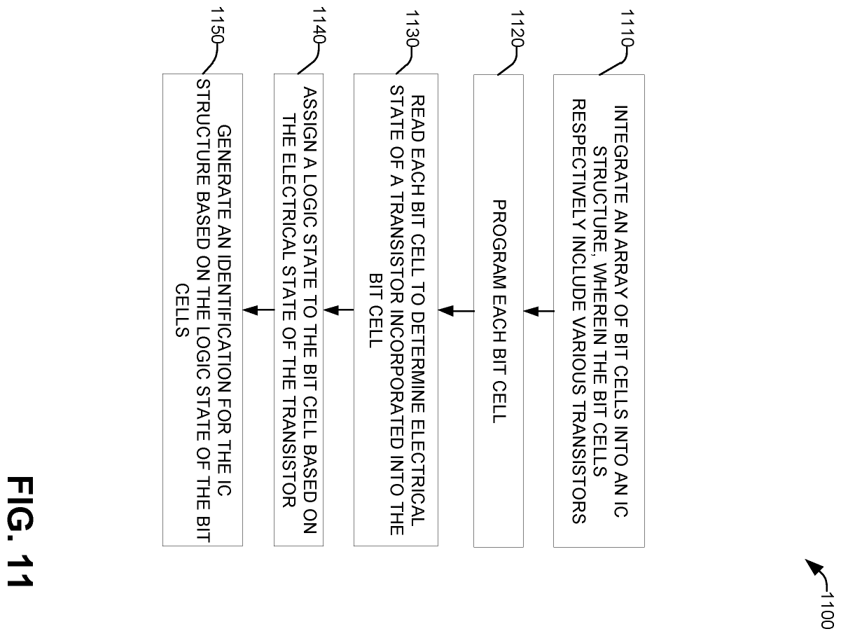

FIG. 9, circuit representation 900, presents a second scenario, where breakdown of the gate dielectric 165 has occurred at DD (e.g., at drain 175 side/BL 196 side), this is equivalent to drain-gate shorting of the second FET 155 (SG PFET). In this scenario, negligible current flows through BL 194, and accordingly, the logic state for the bit cell is assigned as “0” for the second scenario.

FIG. 10 presents system 1000 configured to program and read an identification generated based on breakdown statuses of an array of bit cells comprising two FET structures that include thin gate dielectrics, in accordance with one or more embodiments described herein.

As shown, a row decoder 1010 is connected to an array of wordlines (WL1-n) and a plurality of source lines (SL1-n), wherein the wordlines and source lines are comparable to WL 192 and SL 190, respectively. Further, a column decoder 1020 is connected to an array of bitlines (BL1-m) and complimentary bitlines (BLc1-m), wherein the bitlines and complimentary bitlines are comparable to BL 194 and BLc 196. A collection of bit cells 100A-n are arranged on the array of wordlines, source lines, bitlines and complimentary bitlines, e.g., per structure 100 presented in FIG. 1. The row decoder 1010 and column decoder 1020 provide the input voltages to enable the respective electrical currents and logic states to be determined for each of the bit cells 100A-n, wherein, based on whether breakdown of the gate dielectric 165 has occurred at region DD or DS, the logic states can be “1” or “0” as previously described.

Further, a sense amplifier/analog-to-digital convertor 1030 can be connected to the array of bitlines (BL1-m) and complimentary bitlines (BLc1-m), to enable the respective voltages/electrical currents to be determined on the drain side or source side as described with regard to FIGS. 3-5, and the logic states “1” or “0” to be applied.

FIG. 11 presents a methodology 1100 for generating a unique ID for an IC, in accordance with one or more embodiments described herein.

At 1110, an array of bit cells (e.g., bit cell 100 or 1300 (as further described)) are integrated into an IC structure, wherein the bit cells respectively include various transistors. In an embodiment, a bit cell can include a pair of transistors, wherein a first transistor (e.g., FET 105) in the pair is fabricated with a thick gate dielectric (e.g., dielectric 115) and a second transistor (e.g., FET 155) in the pair is fabricated with a thin gate dielectric (e.g., dielectric 165). In another embodiment, a bit cell can include 3 transistors comprising a pair of transistors (e.g., FETs 1310 and 1320) both fabricated with a thick gate dielectric (e.g., dielectrics 1314 and 1324), and the third transistor (e.g., FET 1330) is fabricated with a thin gate dielectric (e.g., dielectric 1334). With the 3 transistor configuration, the pair of thick gate dielectric transistors combine to create an electric charge on the dielectric of the thin gate dielectric transistor.

At 1120, a bit cell can be programmed, wherein programming utilizes a voltage applied to the respective transistors in the transistor pair bit cell and the triple transistor bit cell. Owing to the respective difference in thickness of the gate dielectrics in the transistor pair bit cell and the triple transistor bit cell, the programming voltage causes breakdown of the respective thin gate dielectric.

At 1130, each bit cell can be read to determine the electrical state of the transistor fabricated with the thin gate dielectric incorporated in each bit cell. Prior to the read operation, the state of thin gate dielectric is effectively unknown after the programming operation has been performed. For the two transistor configuration, the determination can involve identifying whether the thin gate dielectric failed at the source (source-side) or the drain (drain-side) located adjacent to the thin gate dielectric. For the three transistor configuration, the determination can involve identifying whether the thin gate dielectric failed at a first, left-side, source/drain (e.g., S/D 1360) or a second, right-side, source/drain (e.g., S/D 1370), as further described herein.

At 1140, in the event of the thin gate dielectric failed at the source-side (left-side S/D in the three FET configuration) of the thin gate dielectric, a logic state of “1” can be applied to that bit cell. In the event of the thin gate dielectric failed at the drain-side (right-side S/D in the three FET configuration) of the thin gate dielectric, a logic state of “0” can be applied to that bit cell.

At 1150, an identification for the IC structure can be generated based on the respective logic state assigned to the respective bit cell in the array of bit cells.

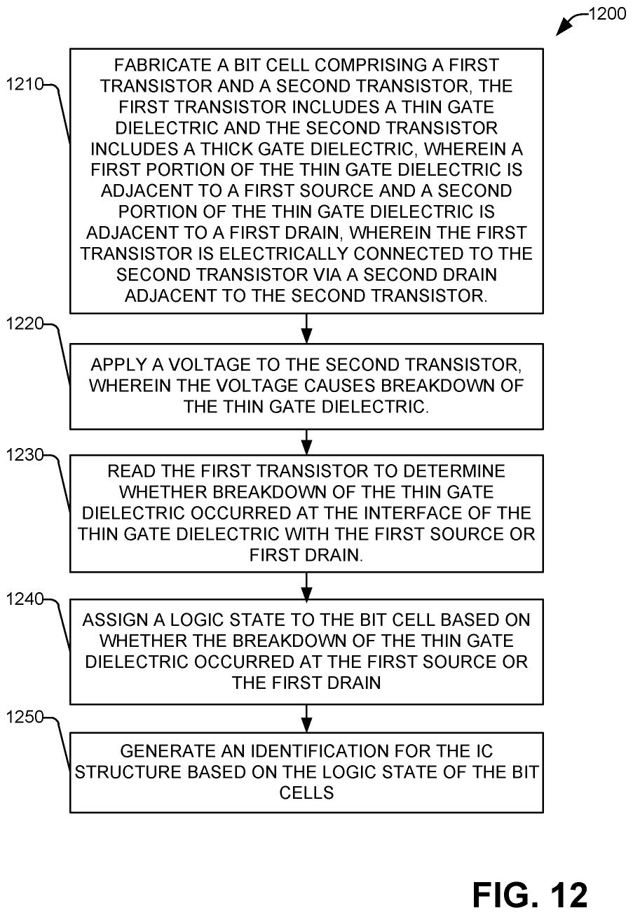

FIG. 12 presents a methodology 1200 for generating a unique ID for an IC, in accordance with one or more embodiments described herein. The following methodology pertains to fabrication of a bit cell configured to include a pair of transistors, e.g., a two FET bit cell.

At 1210, a bit cell (e.g., IC structure 100) can be fabricated comprising a first transistor (e.g., FET 155) and a second transistor (e.g., FET 105). The first transistor can be fabricated to include a thin gate dielectric (e.g., gate dielectric 165). The second transistor can be fabricated to include a thick gate dielectric (e.g., gate dielectric 115), wherein the thickness (T2) of the thin gate dielectric is less than the thickness (T1) of the thick gate dielectric. In an embodiment, a first portion of the thin gate dielectric is adjacent to a first source (e.g., source 170 at DS) and a second portion of the thin gate dielectric is adjacent to a first drain (e.g., drain 175 at DD). In a further embodiment, the first transistor is electrically connected (e.g., via connector 198) to the second transistor via a second drain (e.g., drain 125) adjacent to the thick gate dielectric of the second transistor.

At 1220, the bit cell can be programmed. Programming of the bit cell can include applying a voltage to the second transistor with the voltage being applied to the first transistor as a function of the electrical connection between the second transistor and the first transistor via the second drain. The voltage present at the first transistor can be of sufficient magnitude to cause breakdown of the thin gate dielectric.

At 1230, the first transistor can be read to determine whether breakdown of the thin gate dielectric occurred at the interface of the thin gate dielectric adjacent to the first source (source-side, DS) or adjacent to the first drain (drain-side, DD).

At 1240, where the thin gate dielectric failed at the source-side of the thin gate dielectric, a logic state of “1” can be applied to that bit cell. Alternatively, where the thin gate dielectric failed at the drain-side of the thin gate dielectric, a logic state of “0” can be applied to that bit cell.

At 1250, an identification for the IC structure can be generated based on the respective logic state assigned to the respective bit cell in the array of bit cells, including the bit cell described in steps 1210-1240.

### Three FET Structure and Operation

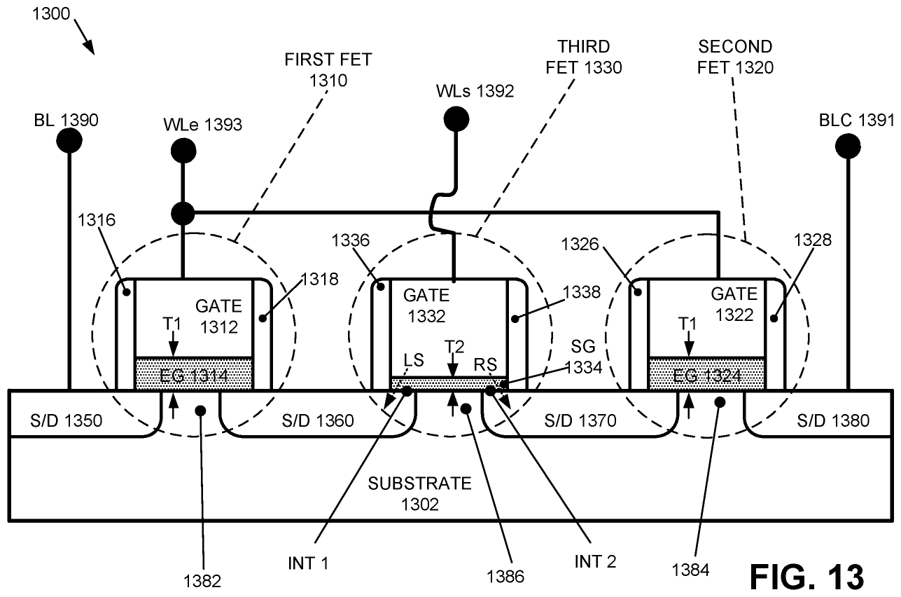

FIG. 13 presents a rudimentary depiction of IC structure bit cell 1300, facilitating identification of the IC as a function of dielectric breakdown, in accordance with one or more embodiments described herein. Various concepts presented regarding operation of bit cell 1300 are similar to those presented for the bit cell 100.

As shown in FIG. 13, bit cell 1300 includes a semiconductor substrate 1302 (e.g., a Si-containing structure) having formed thereon three FETs. A first FET 1310 and a second FET 1320 have similar structures, e.g., are n-type FETs, while a third FET 1330 is located between the first FET 1310 and second FET 1320, wherein the third FET 1330 is a p-type FET. Alternatively, FET 1310 and FET 1320 can be p-type FETs while FET 1330 can be a n-type FET.

The first FET 1310 comprises a first gate electrode 1312 located on a first gate dielectric (EG) 1314, wherein the first gate electrode 1312 and the first gate dielectric 1314 are located between a first left-side spacer 1316 and a second right-side spacer 1318. The first gate dielectric 1314 is located on a first source/drain (S/D) 1350, a second S/D 1360, and a first isolating channel 1382 located between S/D 1350 and S/D 1360, wherein a first portion of the first gate dielectric 1314 is located over and adjacent to a portion of the S/D 1350, a second portion of the first gate dielectric 1314 is located over and adjacent to a portion of the S/D 1360, and a third portion of the first gate dielectric 1314 is located over and adjacent to the first isolating channel 1382 formed in substrate 1302.

The second FET 1320 comprises a second gate electrode 1322 located on a second gate dielectric (EG) 1324, wherein the second gate electrode 1322 and the second gate dielectric 1324 are located between a second left-side spacer 1326 and a second right-side spacer 1328. The second gate dielectric 1324 is located on a third S/D 1370, a fourth S/D 1380, and a second isolating channel 1384 located between S/D 1370 and S/D 1380, wherein a first portion of the second gate dielectric 1324 is located over and adjacent to a portion of the S/D 1370, a second portion of the second gate dielectric 1324 is located over and adjacent to a portion of the S/D 1380, and a third portion of the second gate dielectric 1324 is located over and adjacent to the second isolating channel 1384 formed in substrate 1302.

The third FET 1330 comprises a third gate electrode 1332 located on a third gate dielectric (SG) 1334, wherein the third gate electrode 1332 and the third gate dielectric 1334 are located between a third left-side spacer 1336 and a third right-side spacer 1338. The third gate dielectric 1334 is located on the second S/D 1360, the third S/D 1370, and a third isolating channel 1386 located between S/D 1360 and S/D 1370, wherein a first portion of the third gate dielectric 1334 is located over and adjacent to a portion of the S/D 1360, a second portion of the third gate dielectric 1334 is located over and adjacent to a portion of the S/D 1370, and a third portion of the third gate dielectric 1334 is located over and adjacent to the third isolating channel 1386 formed in substrate 1302.

As further shown, a bitline BL 1390 connects to S/D 1350, a complimentary bitline BLc 1391 connects to S/D 1380, a wordline WLe 1393 connects to the gate electrodes 1312 and 1322 of EG FETs 1310 and 1320, and a wordline WLs 1392 connects to the gate electrode 1332 of FET 1330.

In an embodiment, the first gate dielectric 1314 and the second gate dielectric 1324 have comparable thicknesses, T1, while the third gate dielectric 1334 has a thickness T2, wherein thickness T1>T2. Accordingly, a voltage required to cause breakdown of the third gate dielectric 1334 is less than a voltage required to cause structural breakdown of either of the first gate dielectric 1314 or the second gate dielectric 1324. Hence, the respective thickness T1 of the first gate dielectric 1314 and the second gate dielectric 1324 enables the first FET 1310 and the second FET 1320 to sustain high voltage operation at a voltage which, owing to the thickness T2 of the third gate dielectric 1334, can cause the third gate dielectric 1334 to preferentially breakdown prior to the breakdown of the first gate dielectric 1314 and the second gate dielectric 1324. In a further embodiment, the first FET 1310 and the second FET 1320 can combine (via WLe 1393) to operate as control devices controlling breakdown of the thin third gate dielectric 1334 occurring at the third FET 1330.

THREE FET APPROACH - PROGRAMMING

As previously mentioned, during programming of the bit cell 1300, breakdown of the third gate dielectric 1334 at the third FET 1330 occurs prior to failure of the first gate dielectric 1314 of the first FET 1310 or the second gate dielectric 1324 of the second FET 1320. A voltage to cause breakdown at the gate dielectric 1334 is less than a voltage to cause breakdown of the thicker gate dielectrics 1314 and 1324. Similar to the failure mechanisms of the second gate dielectric 165 as previously described in FIGS. 1-10, the inherent variability arising from fabrication artifacts can cause breakdown of the third gate dielectric 1334 to randomly occur at S/D 1360 or at S/D 1370.

During programming of the bit cell 1300, both of the EG FETS 1310 and 1320 are in an ON operational state with a voltage of 1.8V applied to both of the EG FETS 1310 and 1320, while the SG FET (e.g., FET 1330) is in an OFF operational state as WLs 1392 is grounded. Further, the BL 1390 and BLc 1391 are also in an ON operational state with 1.8V respectively applied thereto. The programming operation on BL, BLc, WLe, and WLs causes a high electric field to be present across the SG gate dielectric 1334 between the gate electrode 1332 and the S/Ds 1360 and 1370, with the high electric field causing breakdown of the gate dielectric 1334.

TABLE 2
VOLTAGES FOR PROGRAM, AND READ OPERATIONS
1 AND 2 AT RESPECTIVE COMPONENTS
IN A THREE FET BIT CELL

| OPERATION | WLe 1393 | WLs 1392 | BL 1390 | BLc 1391 |
|---|---|---|---|---|
| Program | 1.8 V | 0 (ground) | 1.8 V | 1.8 V |
| Read 1 | 1.8 V | 0 | 0.7 V | floating |
| Read 2 | 1.8 V | 0 | floating | 0.7 V |

During programming of the bit cell 1300, in a first scenario, the gate dielectric 1334 can fail to the left side (as indicated LS on FIG. 13) at the interface INT 1 of a first portion of the gate dielectric 1334 and the S/D 1360. In a second scenario, the gate dielectric 1334 can fail to the right side (as indicated RS on FIG. 13) at the interface INT 2 of a second portion of the gate dielectric 1334 and the S/D 1370.

### Three FET Structure—Read Operation

Read operations can be performed to determine whether the gate dielectric 1334 failed on the left side LS or on the right side RS. Using the three FET structure, first measurements can be taken at the EG FET 1310 relative to SG FET 1330 and second measurements can also be taken at the EG FET 1320 relative to the SG FET 1330, thereby the location (LS or RS) at which the gate dielectric 1334 failed can be probed from both sides of the FG FET 1330. Based upon the applied voltages and measured currents, a determination can be made with greater certainty regarding the left side or right side failure of the gate dielectric 1334 than can be achieved by just conducting the measurements of the EG FET 105 relative to the SG FET 155 in the two FET bit cell 100, per FIG. 1. Example operation voltages used during the read operation can be 1.8V on a EG FET 1310 or 1320 and 0.7V on the SG FET 1330.

By measuring the current on BL 1390/BLc 1391, it is possible to determine whether the SG gate dielectric 1334 breaks down to the left (to S/D 1360) or to the right (to S/D 1370), and similar to bit cell 100, a logic state of “1” or “0” can be applied. Owing to the random breakdown of the SG gate dielectric 1334 to S/D 1360 or to S/D 1370, the bit cell 1300 can operate as a random bit generator of “1” or “0”.

### Three FET Structure—Left Side Failure

In a first scenario where the gate dielectric 1334 fails to the left side LS to S/D 1360, a pair of read operations can be performed. With the first read operation, the electric current at the EG FET 1310 is measured. Owing to the gate dielectric 1334 of the SG FET 1330 breaking down at the left S/D 1360 (LS breakdown), the voltage on SG FET at WLs 1392 passes to S/D 1360 at the EG FET 1310 such that Vg at WLe 1393=1.7V, Vd at BL 1390=0, and Vs ˜ WLs 1392=0V. No current flows in the right EG FET 1320, FET 1320 is in an OFF operational state as BLc 1391 is floating.

With the second read operation, the electric current at the EG FET 1320 is measured with BLc 1391 grounded and BL 1390 floating. Because the SG FET 1330 is in an OFF operational sate and the gate dielectric 1334 interfacing with the S/D 1370 is still intact, this results in an equivalent case that the right EG FET 1320 has a floating S/D 1380, such that the measured current is close to zero (except for a small leakage current).

In a situation where the SG gate dielectric 1334 breaks down left side LS to S/D 1360, then during a read operation the current measured at BL 1390 is close to the on-current of EG FET 1310 while the current measured at BLc 1391 is close to zero, as shown in TABLE 2.

### Three FET Structure—Right Side Failure

In a situation where the SG gate dielectric 1334 breaks down right side RS to S/D 1370, during a read operation, current measured at BL 1390 is close to zero, while the current at the BLc 1391 is close to the on-current of the EG FET 1320.

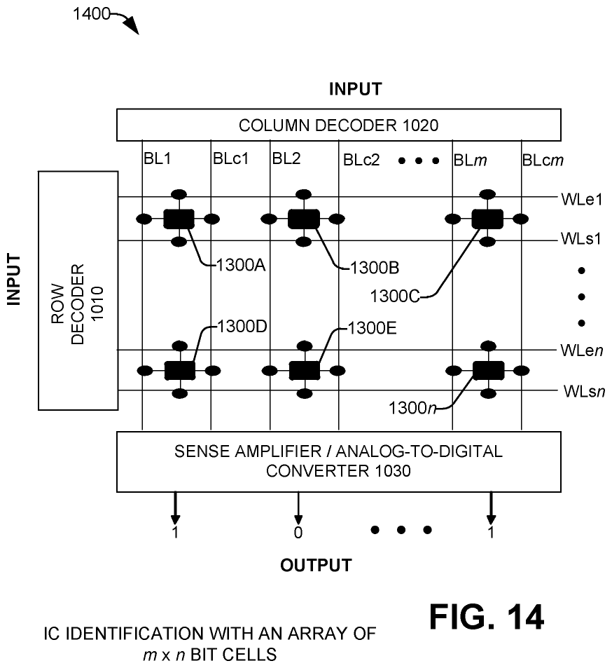

FIG. 14 presents system 1400 configured to read an identification generated based on breakdown statuses of a group bit cells comprising 3 FET structures having thin gate dielectrics, in accordance with one or more embodiments described herein.

As shown, a row decoder 1010 is connected to an array of wordlines (WLs1-n) on SG FETs 1330, wordlines (WLc1-n) on EG FETS 1310 and 1320, wherein the wordlines are comparable to WL 192 and SL 190, respectively. Further, a column decoder 1020 is connected to an array of bitlines 1390 (BL1-m) and complimentary bitlines 1391 (BLc1-m), wherein the bitlines and complimentary bitlines are comparable to BL 194 and BLc 196. A collection of three FET bit cell structures 1300A-n are arranged on the array of wordlines, bitlines, and complimentary bitlines. The row decoder 1010 and column decoder 1020 provide the input voltages to enable the respective logic states to be determined for each of the three FET bit cell structures 1300A-n, based on whether breakdown of the gate dielectric 1334 has occurred at INT 1/left side or INT 2/right side.

Further, a sense amplifier/analog-to-digital convertor 1030 can be connected to the array of bitlines (BL1-m) and complimentary bitlines (BLc1-m), to enable the respective voltages and electric currents to be determined based upon breakdown of the gate dielectric 1334 at INT 1/LS or INT 2/RS, the logic states can be assigned “1” or “0”.

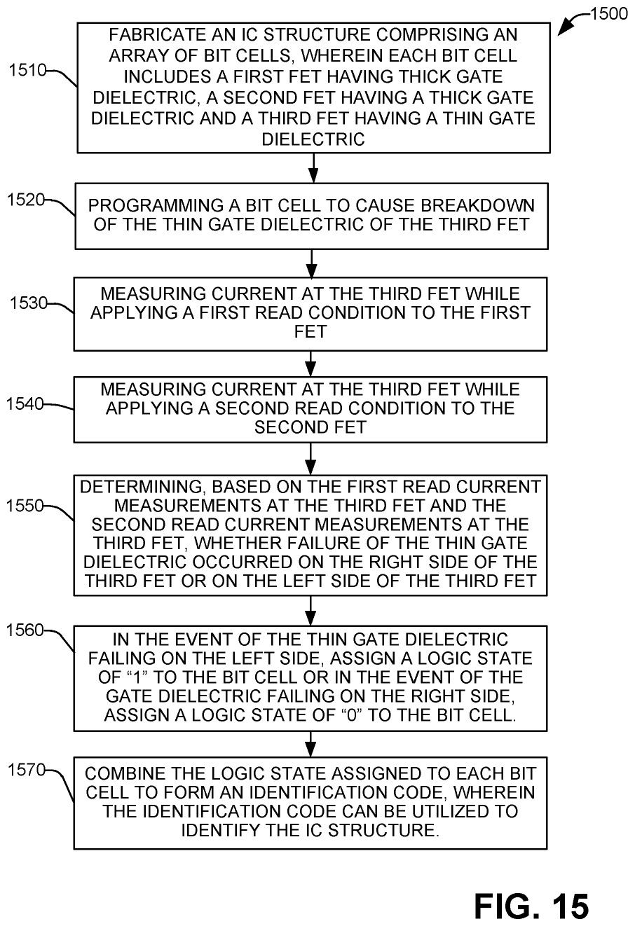

FIG. 15 presents a methodology 1500 for generating a unique ID for an IC, in accordance with one or more embodiments described herein. The following methodology pertains to fabrication of a bit cell configured to include three transistors in the bit cell, wherein the bit cell comprises a pair of transistors configured to control operation of the remaining transistor.

At 1510, a bit cell (e.g., bit cell 1300) can be fabricated comprising a first transistor (e.g., FET 1310), a second transistor (e.g., FET 1320), and a third transistor (e.g., FET 1330). The first transistor and second transistor can combine to control operation of the third transistor. In an embodiment, the first transistor and the second transistor can both be fabricated to include a thick gate dielectric (e.g., gate dielectric 1314, 1324). The third transistor (e.g., FET 1330) can be fabricated to include a thin gate dielectric (e.g., gate dielectric 1334), wherein the thickness of the thin gate dielectric (T1) is less than the thickness (T2) of the thick gate dielectrics. In an embodiment, a first portion of the thin gate dielectric is adjacent to a first source/drain (e.g., S/D 1360 at INT 1) and a second portion of the thin gate dielectric is adjacent to a second source/drain (e.g., S/D 1370 at INT 2). In a further embodiment, the first transistor is electrically connected to the second transistor (e.g., via WLe 1393).

At 1520, the bit cell can be programmed. Programming of the bit cell can include applying a voltage to the first transistor and the second transistor (e.g., via WLe 1393) which results in a voltage being applied to the thin gate dielectric of the third transistor as a function of the second transistor being between and electrically coupled to the first transistor and the second transistor. The thick gate dielectrics of the first transistor and the second transistor can withstand the magnitude of the applied voltage while the thin gate dielectric of the third transistor cannot, and the thin gate dielectric breaks down. Of interest after programming the bit cell is on which side of the thin gate dielectric breaks down.

At 1530, the third transistor can be read to determine whether breakdown of the thin gate dielectric occurred at the interface of the thin gate dielectric on the left side (INT 1) or on the right side (INT 2). In a first read operation, voltages can be applied to the first transistor and one or more electrical currents can be read across the bit cell, e.g., at the wordlines, bitlines (e.g., BL 1390, BLc 1391).

At 1540, in a second read operation, voltages can be applied to the second

transistor and one or more electrical currents can be read across the bit cell, e.g., at the wordlines, bitlines (e.g., BL 1390, BLc 1391).

At 1550, based upon the electrical currents measured at the third transistor during the first read operation and the second read operation, a determination can be made whether the thin gate dielectric failed on the left side (e.g., INT 1) or on the right side (INT 2) of the thin gate dielectric.

At 1560, in the event of the thin gate dielectric being determined to have failed on the left side, a first logic state (e.g., logic state of “1”) is applied to the bit cell. Alternatively, in the event of the thin gate dielectric being determined to have failed on the right side, a second logic state (e.g., a logic state of “0”) is applied to the bit cell.

At 1570, the respective logic state applied to each bit cell located in a bit cell array in a IC can be combined to form an identification code unique to the IC.

### Materials

The following presents various examples of materials that can be utilized to form the respective structures presented in the various embodiments herein:

The substrate 102 and 1302 can be formed from silicon, e.g., epitaxial polysilicon.

The gate dielectrics 115, 165, 1314, 1324, 1334 can be formed from any suitable dielectric material, such as silicon dioxide (SiO₂), a high dielectric constant (high-k) material, etc.

The n-type regions, e.g., channel 180, source 120, drain 125, can be regions of the silicon substrate 102, 1302 doped with phosphorus, antimony, arsenic, etc.

The p-type regions, e.g., channel 130, source 170, drain 175, can be regions of the silicon substrate 102, 1302 doped with gallium, boron, etc.

The respective gate electrodes 110, 160, 1312, 1322, 1332, can also be respectively formed from n-type or p-type doped polysilicon.

The isolating structure, STI, 185 and the spacers 1316, 1318, 1326, 1328, 1336, 1338 can be formed from an oxide such as silicon oxide, tetraethylorthosilicate (TEOS) oxide, high aspect ratio plasma (HARP) oxide, oxides (e.g., silicon oxides) formed by an atomic layer deposition (ALD) process, and the like. Other materials which can be used as nitrides (e.g., silicon nitride, silicon oxynitride, and silicon-rich silicon nitride), silicates, diamond-like carbon, carbide, and the like.

The bitlines 194, 196, 1390, 1391, wordlines 192, 1392, 1393, and source lines

190 can be metallic interconnects or other suitable conductive material.

Owing to the range of transistor architectures to which the various embodiments presented herein can be applied, it is not possible to give specific dimensions of respective components, layers, etc., to provide some context as to the concept of a thin gate dielectric (e.g., gate dielectrics 165, 1334, SG FET) and a thick gate dielectric (e.g., gate dielectrics 115, 1314, 1324, EG FET), a thin gate dielectric can have a thickness of about 1.5 nm to 4 nm (nanometers), with a breakdown voltage (VBD) of about 2V to 3.5V; while a thick gate dielectric can have a thickness of about 3 nm to 7 nm, with a breakdown voltage (VBD) of about 4V to 7V.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A semiconductor device comprising:
a first transistor fabricated to include a first gate electrode and a first gate dielectric, wherein the first gate dielectric is located between the first gate electrode and a first channel region;
a second transistor fabricated to include a second gate electrode and a second gate dielectric, wherein the second gate dielectric is located between the second gate electrode and a second channel region, the second transistor is electrically connected to the first transistor, wherein the second gate dielectric is configured to breakdown prior to breakdown of the first gate dielectric upon application of a voltage to the first transistor.

2. The semiconductor device of claim 1, wherein a thickness of the second gate dielectric between the second gate electrode and the second channel region is thinner than a thickness of the first gate dielectric between the first gate electrode and the first channel region.

3. The semiconductor device of claim 1, further comprising:
a first source region and a first drain region, wherein the first source region is located on a first side of the first channel region and the first drain region is located on a second side of the first channel region wherein the first side of the first channel region and the second side of the first channel region are on opposite sides of the first channel region, and a first portion of the first gate electrode is located adjacent to the first source region and a second portion of the first gate electrode is located adjacent to the first source region; and
a second source region and a second drain region, wherein the second source region is located on a first side of the second channel region and the second drain region is located on a second side of the second channel region wherein:
the first side of the second channel region and the second side of the second channel region are on opposite sides of the second channel region, and a first portion of the second gate electrode is located adjacent to the second source region and a second portion of the second gate electrode is located adjacent to the second source region; and
breakdown of the second gate dielectric occurs at the first portion of the second gate dielectric or at the second portion of the second gate dielectric.

4. The semiconductor device of claim 3, wherein:
in the event of the breakdown of the second gate dielectric occurring at the first portion of the second gate dielectric, a first logic state is applied to the semiconductor device; and
in the event of the breakdown of the second gate dielectric occurring at the second portion of the second gate dielectric, a second logic state is applied to the semiconductor device, wherein the first logic state and the second logic state are disparate.

5. The semiconductor device of claim 4, wherein the semiconductor device is a bit cell identified by the first logic state or second logic state applied thereto.

6. The semiconductor device of claim 5, wherein the bit cell is located in an array of bit cells and the first logic state or second logic state applied to the bit cell is incorporated into an identifier generated based upon the respective logic state applied to each of the bit cells in the bit cell array.

7. The semiconductor device of claim 6, wherein the array of bit cells form a physical unclonable function.

8. The semiconductor device of claim 1, further comprising a third transistor fabricated to include a third gate electrode and a third gate dielectric, wherein:
the third gate dielectric is located between the third gate electrode and a third channel region; and
a first thickness of the first gate dielectric between the first gate electrode and the first channel region and a third thickness of the third gate dielectric between the third gate electrode and the third channel region are equal; and
a second thickness of second gate dielectric between the second gate electrode and the second channel region is less than the first thickness and the third thickness.

9. The semiconductor device of claim 8, wherein the first transistor and the third transistor are connected by a wordline, wherein application of the voltage to the first transistor is also applied to the third transistor via the wordline to cause breakdown of the second transistor.

10. The semiconductor device of claim 1, wherein the breakdown of the second gate dielectric is irreversible.

11. The semiconductor device of claim 1, wherein the voltage is a source-drain voltage.

12. A semiconductor bit cell, comprising:
a first transistor comprising a first gate dielectric located between a first gate electrode and a first channel region, wherein a first source is located on a first side of the first channel region and a first drain is located on a second side of the first channel region, the first gate dielectric has a first thickness between the first gate electrode and the first channel region substrate, and
a second transistor comprising a second gate dielectric located between a second gate electrode and a second channel region, wherein a second source is located on a first side of the second channel region and a second drain is located on a second side of the second channel region, the second gate electrode is electrically connected to the first transistor via the first drain, the second gate dielectric has a second thickness between the second gate electrode and the second channel drain, the second thickness is less than the first thickness, wherein, in the event of a breakdown voltage is applied to the second transistor, the second gate dielectric is configured to irreversibly breakdown prior to breakdown of the first gate dielectric.

13. The semiconductor bit cell of claim 12, wherein a first portion of the second gate dielectric is adjacent to the second source and a second portion of the second gate dielectric is adjacent to the second drain, and breakdown of the second gate dielectric occurs at either the first portion of the second gate dielectric or at the second portion of the second gate dielectric, wherein:
in the event of the breakdown of the second gate dielectric occurs at the first portion of the second gate dielectric, the semiconductor bit cell is in a first logic state; and
in the event of the breakdown of the second gate dielectric occurs at the second portion of the second gate dielectric, the semiconductor bit cell is in a second logic state, wherein the first logic state and second logic state are disparate.

14. The semiconductor bit cell of claim 13, wherein the bit cell is located in an array of bit cells, the logic state of the bit cell is incorporated into an identification code generated based on a logic state respectively assigned to each of bit cells located in the array.

15. A method for creating an identification code for a semiconductor device:
fabricating a bit cell located on the semiconductor device, wherein the bit cell comprises a first transistor including a first gate dielectric having a first thickness and a second transistor including a second gate dielectric having a second thickness, wherein the first thickness is greater than the second thickness and the first transistor is electrically connected to the second transistor; and
applying a voltage to the first transistor wherein the voltage has a magnitude sufficient to cause breakdown of the second gate dielectric and insufficient to cause breakdown of the first gate dielectric.

16. The method of claim 15, wherein the second transistor is located on a channel region, wherein the channel region separates a source region and a drain region, a first portion of the second gate dielectric is adjacent to a first portion of the drain region and a second portion of the second gate dielectric is adjacent to a first portion of the source region.

17. The method of claim 16, further comprising determining whether the breakdown of the second gate dielectric occurred at the first portion of the second gate dielectric or at the second portion of the second gate dielectric.

18. The method of claim 17, further comprising:
in response to determining that breakdown of the second gate dielectric occurred at the first portion of the second gate dielectric, assigning a first logic state to the bit cell,
or in response to determining that breakdown of the second gate dielectric occurred at the second portion of the second gate dielectric, assigning a second logic state to the bit cell, wherein the first logic state and the second logic state are disparate.

19. The method of claim 18, wherein the bit cell is located in an array of bit cells, the assigned logic state is incorporated into an identification code generated based on a logic state respectively assigned to each of bit cells located in the array.

20. The method of claim 15, further comprising fabricating a third transistor including a third gate dielectric having the first thickness, a gate electrode of the third transistor is electrically connected to a gate electrode of the first transistor via a wordline, wherein the voltage applied to the first transistor is applied to the third transistor via the wordline creating an electric field at the second gate dielectric.
